(19) United States
(12) Patent Application Publication
(10) Pub. No.: US 2011/0201277 A1
(43) Pub. Date: Aug. 18, 2011

(54) RADIO COMMUNICATION SYSTEM, RADIO BASE STATION, AND RADIO COMMUNICATION METHOD

(75) Inventor: Hidehiro Eguchi, Yokohama-shi (JP)

(73) Assignee: Kyocera Corporation, Kyoto-shi, Kyoto (JP)

(21) Appl. No.: 13/126,272

(22) PCT Filed: Nov. 5, 2009
(86) PCT No.: PCT/JP2009/068898

§ 371 Date: Apr. 27, 2011

(30) Foreign Application Priority Data
Nov. 7, 2008 (JP) 2008-287088
Nov. 7, 2008 (JP) 2008-287090

(51) Int. Cl. H04B 15/00

(52) U.S. Cl. 455/63.3; 455/63.1

(57) ABSTRACT

In a radio communication method, a radio base station detects, based on CQI information received from a radio terminal, any one of a plurality of subbands, the CQI value of which has been degraded as compared with a threshold value, as an interfered subband (Step S130). The radio base station then notifies interference information, which indicates the interfered subband, to a radio base station (Step S140). The radio base station if currently transmitting an interference signal using the interfered subband, reduces the transmission power of the interference signal or alternatively stops the transmission thereof (Step S150B).

### TECHNICAL FIELD

The present invention relates to a radio communication system in which a radio terminal notifies a radio base station of quality information indicating a radio communication quality of each communication frequency, a radio base station used in the radio communication system, and a radio communication method.

### BACKGROUND ART

Frequency resource is limited in a radio communication system. Thus, various techniques have been developed for utilizing the limited frequency resource to a maximum extent. As one of such techniques, a technique is known in which a communication frequency allocated to a radio terminal by a radio base station is dynamically changed in accordance with a radio communication quality of each communication frequency.

In such a technique, the radio terminal measures respective radio communication qualities of a plurality of communication frequencies and notifies the radio base station of quality information indicating the measurement result. Based on the quality information received from the radio terminal, the radio base station allocates to the radio terminal, a communication frequency with a good radio communication quality from among communication frequencies that can be allocated to the radio terminal.

Thus, the radio terminal can perform radio communications with the radio base station using the communication frequency with a good radio communication quality (i.e., a communication frequency of which a level of interference from a neighboring radio base station is low). Accordingly, stable and high-speed radio communications can be achieved.

In LTE (Long Time Evolution), which is a radio communication system standardized in 3GPP (3rd Generation Partnership Project), quality information on a predetermined number of communication frequencies with the highest radio communication qualities is notified to the radio base station from the radio terminal (see Non-Patent Document 1).

### CITATION LIST

### Non-Patent Document

Non-Patent Document 1: 3GPP TS 36.213 V8.3.0 “7.2 UE procedure for reporting channel quality indication (CQI), precoding matrix indicator (PMI) and rank indication (RI)”

### SUMMARY OF THE INVENTION

However, in a situation where the amount of traffic received and transmitted by the radio base station is large, e.g., when the radio base station performs radio communications with a large number of radio terminals, communication resource falls short and the radio base station cannot always allocate a communication frequency with a good radio communication quality to the radio terminal.

Accordingly, a communication frequency with a degraded radio communication quality (i.e., a communication frequency of which a level of interference from a neighboring radio base station is high) may be al located to the radio terminal. In a conventional radio communication system, there has been a problem that the radio terminal cannot achieve the stable and high-speed radio communications in such a case.

Thus, an objective of the present invention is to provide a radio communication system, a radio base station, and a radio communication method with which, even when the communication frequency with a degraded radio communication quality is allocated to a radio terminal, the radio communication quality of the communication frequency can be improved to thereby allow the stable and high-speed radio communications to be achieved.

In order to solve the problems described above, the present invention has the following characteristics. First of all, according to a first characteristic of the present invention, there is provided a radio communication system (radio communication system 10) comprising: a first radio base station (radio base station 1A) configured to perform radio communications with a radio terminal (radio terminal 2A) and to receive quality information indicating radio communication qualities from the radio terminal, the radio communication qualities being respectively measured for a plurality of communication frequencies available in the radio communications by the radio terminal; a second radio base station (radio base station 1B) located within a predetermined distance from the first radio base station and configured to be capable of communicating with the first radio base station, wherein the first radio base station includes: a detector (interfered subband detector 123) configured to detect a communication frequency of which the radio communication quality is degraded below a threshold value as an interfered communication frequency from among the plurality of communication frequencies based on the quality information received from the radio terminal; and an interference information notifying unit (notification processor 124) configured to notify the second radio base station of interference information indicating the interfered communication frequency when the interfered communication frequency is detected by the detector, and the second radio base station includes a transmission controller (transmission controller 223) configured to perform any one of transmission power lowering and transmission stop for an interference signal that is a radio signal for which the interfered communication frequency is used, when receiving the interference information from the first radio base station and when the second radio base station is transmitting the interference signal.

In such a radio communication system, the interference information notifying unit notifies the second radio base station of the interference information indicating the interfered communication frequency when the interfered communication frequency is detected. The transmission controller of the second radio base station performs any one of the transmission power lowering and the transmission stop for the interference signal when the second radio base station is transmitting the interference signal. Thus, the radio communication quality in the interfered communication frequency is improved. Thus, even when the communication frequency (i.e., interfered communication frequency) with the degraded radio communication quality is allocated to the radio terminal, the radio communication quality in the communication frequency can be improved and stable and high-speed radio communication can be achieved.

A second characteristic of the present invention is according to the first characteristic of the present invention and is summarized in that: the first radio base station further includes a location information acquiring unit (location information acquiring unit 121b) configured to acquire location information indicating anyone of a location of the radio terminal and a distance between the radio terminal and the first radio base station, and the detector is configured to detect the degraded communication frequency as the interfered communication frequency when the degraded communication frequency exists and when the radio terminal is determined to be located in an edge portion of a communication area of the first radio base station based on the location information.

A third characteristic of the present invention is according to the first characteristic of the present invention and is summarized in that: the first radio base station further includes: a quality information receiver (radio communication unit 110) configured to receive the quality information from the radio terminal for a plurality of times or to receive the quality information from a plurality of radio terminals including the radio terminal; and a counting unit (counting unit 122c) configured to count the number of times the radio communication quality degrades below the threshold value for each of the plurality of communication frequencies, and the detector is configured to detect the degraded communication frequency as the interfered communication frequency when the degraded communication frequency exists and when the number of times counted by the counting unit for the degraded communication frequency reaches a predetermined number.

A fourth characteristic of the present invention is according to the first characteristic of the present invention and is summarized in that: the radio terminal is configured: to extract a predetermined number of lowest radio communication qualities from among the radio communication qualities respectively measured for the plurality of communication frequencies, and to notify the first radio base station of the quality information indicating the predetermined number of the lowest radio communication qualities extracted.

A fifth characteristic of the present invention is according to the first characteristic of the present invention and is summarized in that: when the interfered communication frequency is allocated to another radio terminal (radio terminal 2B) different from the radio terminal and when an unallocated communication frequency different from the interfered communication frequency exists, the transmission controller is configured to perform the transmission stop and to allocate the unallocated communication frequency to the other radio terminal.

A sixth characteristic of the present invention is according to the first characteristic of the present invention and is summarized in that: the transmission controller is configured to perform the transmission power lowering when the unallocated communication frequency does not exist.

According to a seventh characteristic of the present invention, there is provided a radio base station (radio base station 1A) configured to perform radio communications with a radio terminal (radio terminal 2A) and to receive quality information indicating radio communication qualities from the radio terminal, the radio communication qualities being respectively measured for a plurality of communication frequencies of a predetermined number by the radio terminal, the radio base station comprising: a detector (interfered subband detector 123) configured to detect a communication frequency of which the radio communication quality is degraded below a threshold value as an interfered communication frequency from among the plurality of communication frequencies based on the quality information received from the radio terminal; and an interference information notifying unit (notification processor 124) configured to notify another radio base station (radio base station 1B, for example) located within a predetermined distance from the radio base station of interference information indicating the interfered communication frequency when the interfered communication frequency is detected by the detector.

According to an eighth characteristic of the present invention, there is provided a radio base station (radio base station 1B) configured to perform radio communications with a radio terminal (radio terminal 2A) and to be capable of communicating with another radio base station (radio base station 1A) that receives quality information indicating radio communication qualities from the radio terminal, the radio communication qualities being respectively measured for a plurality of communication frequencies available in the radio communications by the radio terminal, the radio base station comprising: an interference information receiver (wired communication unit 240) configured to receive from the other radio base station, interference information indicating an interfered communication frequency of which the radio communication quality is degraded below a threshold value from among the plurality of communication frequencies; and a transmission controller (transmission controller 223) configured to perform any one of transmission power lowering and transmission stop for an interference signal that is a radio signal for which the interfered communication frequency is used when receiving the interference information by the interference information receiver in a case where the radio base station is transmitting the interference signal.

According to a ninth characteristic of the present invention, there is provided a radio communication method using: a first radio base station configured to perform radio communications with a radio terminal and receive quality information indicating radio communication qualities from the radio terminal, the radio communication qualities being respectively measured for a plurality of communication frequencies available in the radio communications by the radio terminal; and a second radio base station located within a predetermined distance from the first radio base station and configured to be capable of communicating with the first radio base station, the radio communication method comprising the steps of: detecting (Step S135) a communication frequency of which the radio communication quality is degraded below a threshold value as an interfered communication frequency from among the plurality of communication frequencies based on the quality information received by the first radio base station from the radio terminal; and notifying (Step S140) the second radio base station by the first radio base station of interference information indicating the interfered communication frequency when the interfered communication frequency is detected in the step of detecting the communication frequency, and performing (Step S154 or Step S155) any one of transmission power lowering and transmission stop by the second radio base station for an interference signal that is a radio signal for which the interfered communication frequency is used when receiving the interference information by the second radio base station from the first radio base station and when the second radio base station is transmitting the interference signal.

According to a tenth characteristic of the present invention, there is provided a radio base station (radio base station 1A) configured to perform radio communications with a radio terminal (radio terminal 2A) and receive quality information indicating radio communication qualities from the radio terminal, the radio communication qualities being respectively measured for a plurality of communication frequencies available in the radio communications by the radio terminal, the radio base station comprising: a detector (interfered subband detector 123) configured to detect a communication frequency of which the radio communication quality is degraded below a threshold value as an interfered communication frequency from among the plurality of communication frequencies based on the quality information received from the radio terminal; an information acquiring unit (information acquiring unit 121) configured to acquire terminal location information indicating a location of the radio terminal and base station location information on locations of other radio base stations (neighboring radio base stations 1B to 1G) within a predetermined rage from the radio base station; an interference source identifying unit (interference source identifying unit 125) configured to identify an interference source base station transmitting to the radio terminal an interference signal that is a radio signal for which the interfered communication frequency is used from among the other radio base stations based on the is terminal location information and the base station location information when the interfered communication frequency is detected by the detector; and an instructing unit (notification processor 124) configured to instruct any one of transmission power lowering and transmission stop for the interference signal to the interference source base station identified by the interference source identifying unit.

In such a radio base station, the detector detects the interfered communication frequency, the interference source identifying unit identifies the interference source base station transmitting the interference signal to the radio terminal, and the instructing unit instructs the interference source bae station to perform any one of the transmission power lowering and the transmission stop for the interference signal. Thus, the transmission of the interference signal is restricted and the radio communication quality in the interfered communication frequency is improved.

Thus, even when the communication frequency (i.e., interfered communication frequency) with the degraded radio communication quality is allocated to the radio terminal, the radio communication quality in the communication frequency can be improved and stable and high-speed radio communication can be achieved.

An eleventh characteristic of the present invention is according to the tenth characteristic of the present invention and is summarized in that: the radio base station further comprising: a quality information receiver (radio communication unit 110) configured to receive the quality information from the radio terminal for a plurality of times or receive the quality information from a plurality of radio terminals including the radio terminal; and a counting unit (counting unit 122c) configured to count the number of times the radio communication quality degrades below the threshold value for each of the plurality of communication frequencies, wherein the detector is configured to detect the degraded communication frequency as the interfered communication frequency when the degraded communication frequency exists and when the number of times counted by the counting unit for the degraded communication frequency reaches a predetermined number.

A twelfth characteristic of the present invention is according to the tenth characteristic of the present invention and is summarized in that: the detector is configured to detect the degraded communication frequency as the interfered communication frequency when the degraded communication frequency exists and when the radio terminal is determined to be located in an edge portion of a communication area of the radio base station based on the terminal location information.

A thirteenth characteristic of the present invention is according to the tenth characteristic of the present invention and is summarized in that: the quality information received from the radio terminal indicates a predetermined number of lowest radio communication qualities from among the radio communication qualities respectively measured for the plurality of communication frequencies by the radio terminal.

A fourteenth characteristic of the present invention is according to the tenth characteristic of the present invention and is summarized in that: the interference source identifying unit is configured: to calculate the distance between the radio terminal and each of the other radio base stations, and to identify a radio base station with the shortest measured distance as the interference source base station from among the other radio base stations.

A fifteenth characteristic of the present invention is according to the tenth characteristic of the present invention and is summarized in that: the base station location information includes information indicating a communication area formed by each of the other radio base stations, and the interference source identifying unit is configured to identify a radio base station forming the communication area including the location of the radio terminal as the interference source base station from among the other radio base stations.

A sixteenth characteristic of the present invention is according to the tenth characteristic of the present invention and is summarized in that: the information acquiring unit is configured to acquire base station identifying information for identifying the interference source base station instead of the terminal location information and the base station location in information, the base station identifying information being included in the interference signal received by the radio terminal, and the interference source identifying unit is configured to identify the interference source base station based on the base station identifying information.

According to a seventeenth characteristic of the present invention, there is provided a radio communication method used in a radio base station configured to perform radio communications with a radio terminal and receive quality information indicating radio communication qualities from the radio terminal, the radio communication qualities being respectively measured for a plurality of communication frequencies available in the radio communications by the radio terminal, the radio communication method comprising the steps of: detecting (Step S214) a communication frequency of which the radio communication quality is degraded below a threshold value as an interfered communication frequency from among the plurality of communication frequencies based on the quality information received from the radio terminal; and acquiring terminal location information indicating a location of the radio terminal and base station location information on locations of other radio base stations within a predetermined rage from the radio base station; identifying (Step S220) an interference source base station transmitting to the radio terminal an interference signal that is a radio signal for which the interfered communication frequency is used from among the other radio base stations based on the terminal location information and the base station location information when the interfered communication frequency is detected in the step of detecting the communication frequency; and instructing (Step S230) any one of transmission power lowering and transmission stop for the interference signal to the interference source base station identified in the step of identifying the interference source base station.

### BRIEF DESCRIPTION OF THE DRAWINGS

FIG. 1 is a schematic configuration diagram of a radio communication system according to a first embodiment.

FIG. 2 is a diagram for explaining neighboring radio base stations.

FIG. 3 is a functional block diagram showing a configuration of a radio base station (first radio base station) according to the first embodiment.

FIG. 4 is a functional block diagram showing a configuration of a radio base station (second radio base station) according to the first embodiment.

FIG. 5 is a sequence diagram showing a schematic operation sequence of the radio communication system according to the first embodiment.

FIG. 6 is a flowchart showing an operation of the radio base station (first radio base station) according to the first embodiment, more specifically, a detail of Step S130 shown in FIG. 5.

FIG. 7 is a flowchart showing an operation of the radio base station (second radio base station) according to the first embodiment, more specifically, a detail of Step S150B shown in FIG. 5.

FIG. 8 is a functional block diagram showing a configuration of a radio base station according to a second embodiment.

FIG. 9 is a sequence diagram showing a schematic operation sequence of the radio communication system according to the second embodiment.

FIG. 10 is a flowchart showing an operation of the radio base station (first radio base station) according to the second embodiment, more specifically, a detail of Step S210 shown in FIG. 9.

### DESCRIPTION OF EMBODIMENTS

Next, descriptions will be given of radio communication systems according to first, second and other embodiments of the present invention with reference to the drawings. Note that, in the following description of the drawings, same or similar reference signs denote same or similar portions.

### First Embodiment

In the first embodiment, descriptions are given of (1) a schematic configuration of a radio communication system, (2) a configuration of a radio base station, (3) an operation of the radio communication system, and (4) advantageous effects.

(1) Schematic Configuration of Radio Communication System

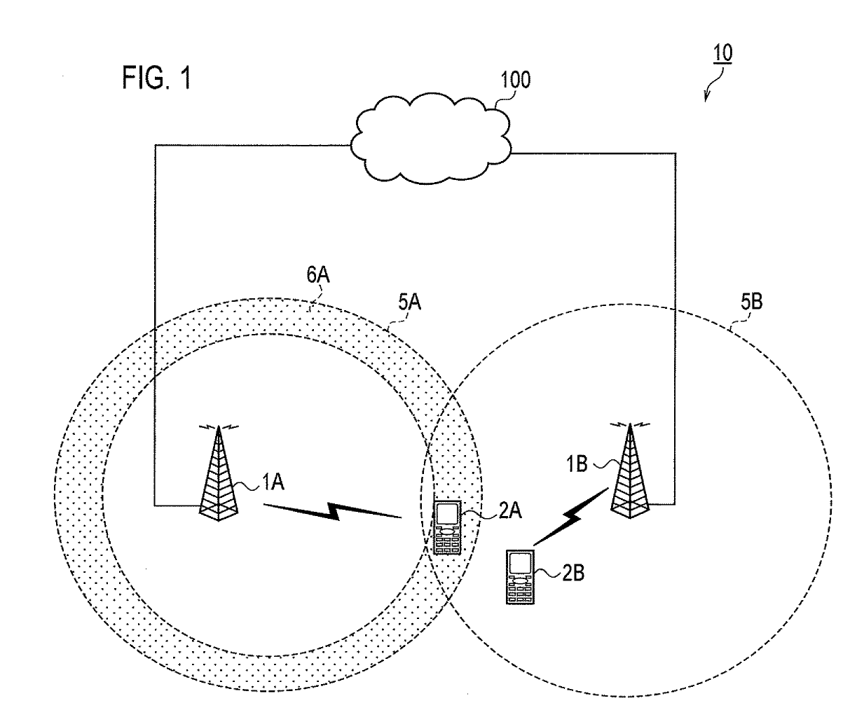

FIG. 1 is a schematic configuration diagram of a radio communication system 10 according to the first embodiment. The radio communication system 10 has a configuration based on the LTE standard. Specifically, orthogonal frequency division multiple access (OFDMA) scheme, which is one of the multi-carrier communication schemes, is used in the radio communication system 10. In the OFDMA scheme, a communication channel called a subchannel is formed of multiple subcarriers and the communication channel is allocated to a radio terminal.

As shown in FIG. 1, the radio communication system 10 includes a radio base station 1A, a radio base station 1B, and multiple radio terminals 2A and 28. The radio base station 1A (first radio base station) forms a communication area 5A in which communications with a radio terminal is possible. The communication area 5A is within a range of radio communication of the radio base station 1A and is also called a cell.

The radio terminal 2A is located within the communication area 5A and performs radio communications with the radio base station 1A through a communication channel allocated by the radio base station 1A. A large number of radio terminals 2A may be located in the communication area 5A and perform radio communications with the radio base station 1A instead of a single radio terminal 2A as shown in FIG. 1. When a large number of radio terminals 2A perform radio communications with the radio base station 1A as described above, radio communication resource of the radio base station 1A falls short.

The radio base station 1B (second radio base station) forms a communication area 58 and performs radio communications with the radio terminal 2B located in the communication area 5B. A large number of radio terminals in addition to the radio terminal 2B may be located in the communication area 5B.

The radio base station 1A and the radio base station 1B are connected to a backbone network 100 that is a wired communication network. The radio base station 1A and the radio base station 1B can communicate with each other through the backbone network 100.

The communication area 5A formed by the radio base station 1A and the communication area 53 formed by the radio base station 1B are so-called neighboring cells that partly overlap with each other. In the example shown in FIG. 1, the radio terminal 2A is located in the overlapping area of the communication area 5A and the communication area 5B.

The communication channel allocated to the radio terminal 2A by the radio base station 1A and the communication channel allocated to the radio terminal 23 by the radio base station 1B are communication channels of the same frequency or of neighboring frequencies, for example. The radio terminal 2A, which is located in an edge portion (hereinafter, referred to as “area edge”) 6A of the communication area 5A that overlaps with the communication area 5B, is largely affected by the interference from the radio base station 1B.

More specifically, a radio signal transmitted from the radio base station 1B to the radio terminal 2B is received not only by the radio terminal 2B but also by the radio terminal 2A. In the following, radio communications between the radio base station 1A and the radio terminal 2A are mainly described and a radio signal received by the radio terminal 2A from the radio base station 1B is referred to as an interference signal.

In the OFDMA scheme, the communication channel allocated to the radio terminal 2A by the radio base station 1A can be dynamically changed. Moreover, the radio communication system 10 employs an adaptive modulation. In the adaptive modulation, radio communications can be achieved with faster modulation scheme with the better radio communication quality (SNR and CINR) between the radio base station 1A and the radio terminal 2A.

In view of the above, in the radio communication system 10, the radio terminal 2A measures the communication quality and notifies the radio base station 1A of the measured radio communication quality. Specifically, the radio terminal 2A measures the radio communication quality of each frequency called a subband in which multiple subcarriers are gathered together. In the LTE standard, the entire frequency band available in the radio communication system 10 is divided into about 50 subbands. Moreover, in the LTE standard, a value called CQI (Channel Quality Indication) is used as an index of the radio communication quality. In the 3GPP standard specification “3GPP TS 36.213 V8.3.0”, a scheme is defined in which a radio terminal notifies a radio base station of CQIs of M subbands with the highest CQIs. Thus, the radio base station can determine a subband suitable for the radio terminal.

In the first embodiment, the radio terminal 2A extracts lowest N CQIs for example, from among the CQIs respectively measured for the multiple subbands and notifies the radio base station 1A of CQI information indicating the extracted lowest N CQIs.

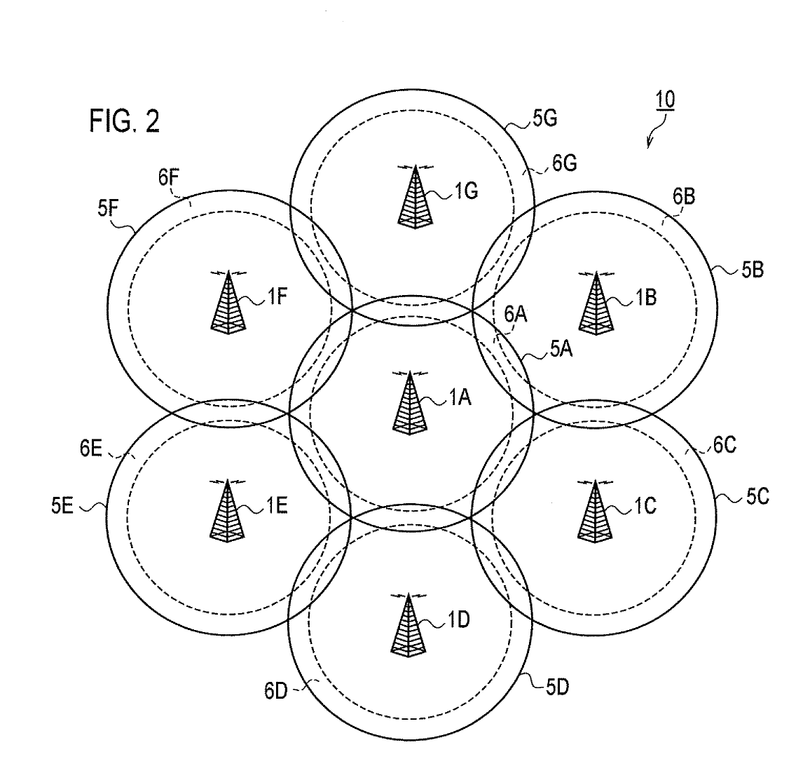

As shown in FIG. 2, multiple neighboring radio base stations 1B to 1G are installed at the periphery of the radio base station 1A. The area edge 6A of the communication area 5A formed by the radio base station 1A overlaps with area edges 6B to 6G of the respective communication areas 5B to 5G respectively formed by the neighboring radio base stations 1B to 1G.

Based on the CQI information received from the radio terminal 2A, the radio base station 1A detects an interfered subband which is largely interfered by the neighboring radio base stations 1B to 1G from among the multiple subbands and notifies the neighboring radio base stations 1B to 1G of information on the interfered subband. The neighboring radio base stations 1B to 1G perform processing to reduce the interference in accordance with the notified information. In the following, of the neighboring radio base stations 1B to 1G, the radio base station 1B is representatively described.

(2) Configuration of Radio Base Station

Next, (2.1) a configuration of the radio base station 1A and (2.2) a configuration of the radio base station 1B are described.

(2.1) Configuration of Radio Base Station 1A

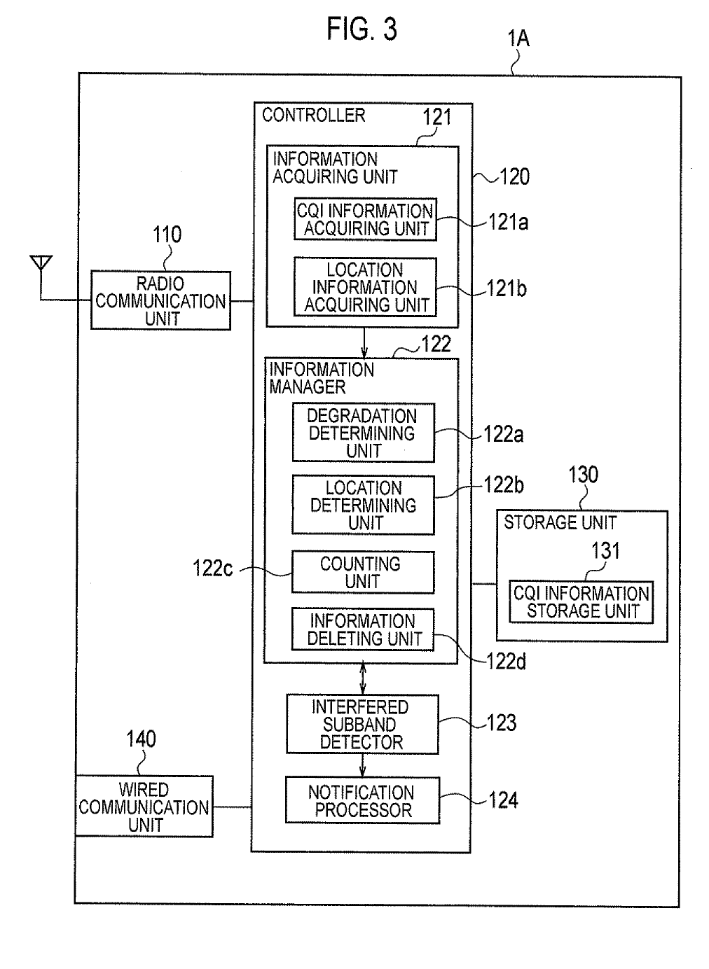

FIG. 3 is a functional block diagram showing a configuration of the radio base station 1A according to the first embodiment.

As shown in FIG. 3, the radio base station 1A includes a radio communication unit 110, a controller 120, a storage unit 130 and a wired communication unit 140.

The radio communication unit 110 includes an LNA (Low Noise Amplifier), a power amplifier, an up-converter, a down-converter, and the like and receives and transmits a radio signal based on the OFDMA. The radio communication unit 110 forms a quality information receiver configured to receive the CQI information (quality information) from the radio terminal 2A.

The wired communication unit 140 serves as an interface with the backbone network 100. The controller 120 is formed of a CPU for example, and controls various functions of the radio base station 1A. The storage unit 130 is formed of a memory for example and stores various pieces of information used for the control in the radio base station LA.

The controller 120 includes an information acquiring unit 121, an information manager 122, an interfered subband detector 123, and a notification processor 124.

The information acquiring unit 121 includes a location information acquiring unit 121b that acquires location information (terminal location information) indicating the location of the radio terminal 2A and a CQI acquiring unit 121a that acquires CQI information notified from the radio terminal 2A. The CQI acquiring unit 121a receives CQI information from a single radio terminal 2A for multiple times or receives the CQI information from multiple radio terminals 2A. The location information acquiring unit 121b acquires location information indicating at least the location of the radio terminal 2A or the distance between the radio terminal 2A and the radio base station 1A.

The information manager 122 stores the CQI information acquired by the information acquiring unit 121 in a CQI information storage unit 131 of the storage unit 130 and manages the CQI information.

The information manager 122 includes a degradation determining unit 122a, a location determining unit 122b, a counting unit 122c, and an information deleting unit 122d. Based on the CQI information, the degradation determining unit 122a determines whether or not a subband of which the CQI is degraded below a threshold value exists in the multiple subbands. Based on the location information, the location determining unit 122b determines whether or not the radio terminal 2A is located at the area edge 6A of the radio base station 1A. The counting unit 122c counts the number of times the CQI degrades below the threshold value for each of the multiple subbands. The information deleting unit 122d deletes the old information from among the CQI information pieces stored in the CQI information storage unit 131.

The interfered subband detector 123 detects the interfered subband by using the information managed by the information manager 122. The notification processor 124 notifies the neighboring radio base stations 1B to 1G of interference information indicating the interfered subband detected by the interfered subband detector 123. Thus, the notification processor 124 forms an interference information notifying unit in the first embodiment.

Processing performed by each of the functional blocks of the radio base station 1A is described in detail below. Specifically, descriptions are given of (2.1.1) acquisition of terminal location information, (2.1.2) acquisition of CQI information, (2.1.3) management of CQI information, (2.1.4) detection of interfered subband and (2.1.5) notification of interference information.

(2.1.1) Acquisition of Terminal Location Information

The location information acquiring unit 121b acquires the location information of the radio terminal 2A using any one of the following methods A to C.

A. The radio terminal 2A measures the self location using location information detection means such as a GPS installed in the radio terminal 2A and notifies the radio base station 1A of the location information. As the timing at which the radio terminal 2A notifies the location information, notifying upon initial connection to the radio base station 1A, notifying at predetermined intervals, notifying upon change of the location information, and the like may be considered.

B. Location estimation with the radio base station 1A measuring reception power, Doppler frequency, and the like of the electronic wave transmitted by the radio terminal 2A. In some cases, the location of the radio terminal 2A can be accurately detected from the results of the measurements by multiple base stations.

C. Distance estimation based on the difference between a timing at which the radio base station 1A receives a radio signal transmitted by the radio terminal 2A and a timing at which the radio base station 1A transmits a signal; distance estimation through notification of timing advance (TA) information performed by the radio terminal 2A; or the combination of these.

(2.1.2) Acquisition of CQI Information

The CQI information acquiring unit 121a cannon-periodically acquire a CQI from the radio terminal 2A by requesting it to the radio terminal 2A. Here, a subband with CQI with low measurement result is notified. As the number of CQIs to be notified from the radio terminal 2A, the lowest M CQIs, CQIs lower than or equal to a predetermined threshold value, or the lowest M CQIs from among the CQIs lower than or equal to a predetermined threshold value and the like may be considered. The method of making the radio terminal 2A recognize the criteria (the number M or the threshold value) includes system fix, notifying by broadcast information, notifying by configuration upon initial connection of the radio terminal 2A, and the like.

(2.1.3) Management of COI Information

In the above described C, the information manager 122 stores the CQI information pieces in the CQI information storage unit 131 with respect to distances of the radio terminal. Alternatively, the information manager 122 may store only the CQI of the radio terminal determined to be located at the area edge 6A by the location determining unit 122b in the CQI information storage unit 131.

The information manager 122 stores the CQI information in the CQI information storage unit 131 by any one of the following methods D to F.

D. Method of storing a subband and a CQI together with terminal ID.

E. Method of storing a CQI for each subband.

F. Method of storing the number of times the CQI not larger than the threshold value is notified for each subband.

When the storing methods are arranged in order of amount of memory required, D.>E.>F holds true. The larger amount of information is directly related to the larger amount of memory of the information storage unit 131, but allows the interference detection of a higher level.

In any of the methods, the information deleting unit 122d deletes old information pieces after certain time (TBD) has passed because currently received interference cannot be accurately estimated by the determination based on the old information pieces.

Examples of CQI information pieces stored by the method E are shown in Table 1.

TABLE 1

| Subband Number | CQI 1 | CQI 2 | CQI 3 | CQI 4 | CQI 5 | CQI 6 | CQI 7 | CQI 8 |
|---|---|---|---|---|---|---|---|---|
| 1 Elapsed | xx dB | xx dB | xx dB | xx dB | xx dB | xx dB | | |
| Time | 1 | 3 | 4 | 7 | 15 | 16 | | |
| 2 Elapsed | | | | | | | | |
| Time | | | | | | | | |
| 3 Elapsed | | | | | | | | |
| Time | | | | | | | | |
| 4 Elapsed | | | | | | | | |
| Time | | | | | | | | |

In Table 1, a notified CQI and a value corresponding to the elapsed time after the notification are recorded for each of the subbands with the respective subband numbers 1 to 4. The value corresponding to the elapsed time is decremented (subtracted by 1) along with the elapse of time. When the value reaches zero, the CQI with the value is deleted.

(2.1.4) Detection of Interfered Subband

Generally, a subband with a low CQI is estimated to be receiving a higher level of interference. Thus, interfered level can be estimated to be high when the degradation determining unit 122a determines that the CQI is not larger than the predetermined threshold value. The interfered subband detector 123 may determine a subband as the interfered subband upon detecting a CQI corresponding to a condition for multiple times is observed using the counting unit 122c to eliminate a momentary factor.

When storing information as in the above described F, the counting unit 122c counts the number of times a CQI is not larger than the threshold value for each subband. The interfered subband detector 123 determines a subband as the interfered subband when the counted value reaches or exceeds the predetermined number.

Similar determination is possible in the above described E. In this case, since the CQI is stored for each subband, the interfered subband detector 123 may weight each subband by the level of CQI to thereby determine a high interference even when the counted number of times the CQI is not larger than the threshold value is small.

In the D., a radio terminal from which each CQI is notified can also be identified. Thus, when a CQI of a specific radio terminal is low, an individual factor such as malfunctioning of the terminal can be identified.

(2.1.5) Notification of Interference Information When the interfered subband detector 123 detects an interfered subband, the notification processor 124 notifies the neighboring radio base stations 1B to 1G of the interference information through the backbone network 100. For example, the interference information includes a subband number for identifying the interference subband. Notified one of the neighboring radio base stations 1B to 1G avoids using the interfered subband or uses the interfered subband with low transmission power in accordance with their traffic conditions. The notification processor 124 may notify instruction message with strong coercive force that forces the use of the interfered subband to be stopped or an output to be lowered.

(2.2) Configuration of Radio Base Station 1B

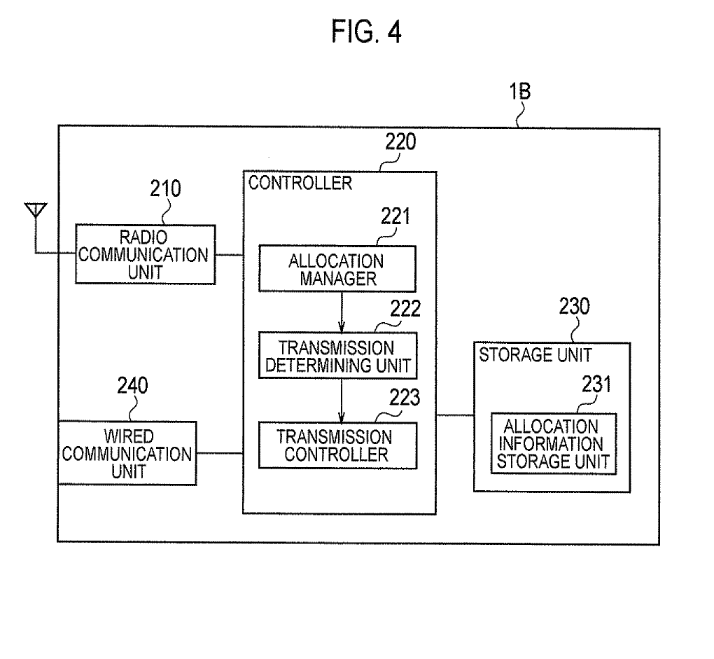

Next, (2.1) a configuration of the radio base station 1B is described. FIG. 4 is a functional block diagram showing a configuration of a radio base station 1B.

As shown in FIG. 4, the radio base station 1B includes a radio communication unit 210, a controller 220, a storage unit 230 and a wired communication unit 240. The radio communication unit 210 includes an LNA, a power amplifier, an up-converter, a down-converter, and the like and receives and transmits a radio signal based on the OFDMA. The wired communication unit 240 serves as an interface with the backbone network 100. The wired communication unit 240 serves as an interference information receiver that receives the interference information through the backbone network 100.

The controller 220 is formed of a CPU for example and controls various functions of the radio base station 1B. The storage unit 230 is formed of a memory for example and stores various pieces of information used for the control in the radio base station 13.

The controller 220 includes an allocation manager 221, a transmission determining unit 222, and a transmission controller 223. The allocation manager 221 allocates a communication channel to the radio terminal 2B and manages the allocated communication channel and information on the subband including the communication channel. The allocation information managed by the allocation manager 221 is stored in the storage unit 230 (allocation information storage unit 231).

The transmission determining unit 222 identifies the interfered subband based on the interference information received from the radio base station 1A and determines whether or not an interference signal for which the interfered subband is used is transmitted by the radio base station 1B. More specifically, the transmission determining unit 222 determines whether or not a communication channel of a frequency corresponding to the interference subband is allocated to the radio terminal 2B, based on the allocation information managed by the allocation manager 221. The transmission determining unit 222 determines that the radio base station 1B is transmitting the interference signal, when the communication channel of the frequency corresponding to the interference subband is allocated to the radio terminal 2B.

The transmission controller 223 controls the radio communication unit 210 in accordance with the result of determination by the transmission determining unit 222. The transmission controller 223 per forms any one of transmission power lowering and transmission stop for the interference signal when the transmission determining unit 222 determines that the radio base station 1B is transmitting the interference signal.

(3) Operation of Radio Communication System

Next, an operation of the radio communication system 10 according to the first embodiment is described. Specifically, descriptions are given of (3.1) an overall schematic operation, (3.2) an operation of the radio base station 1A, and (3.3) an operation of the radio base station 1B.

(3.1) Overall Schematic Operation

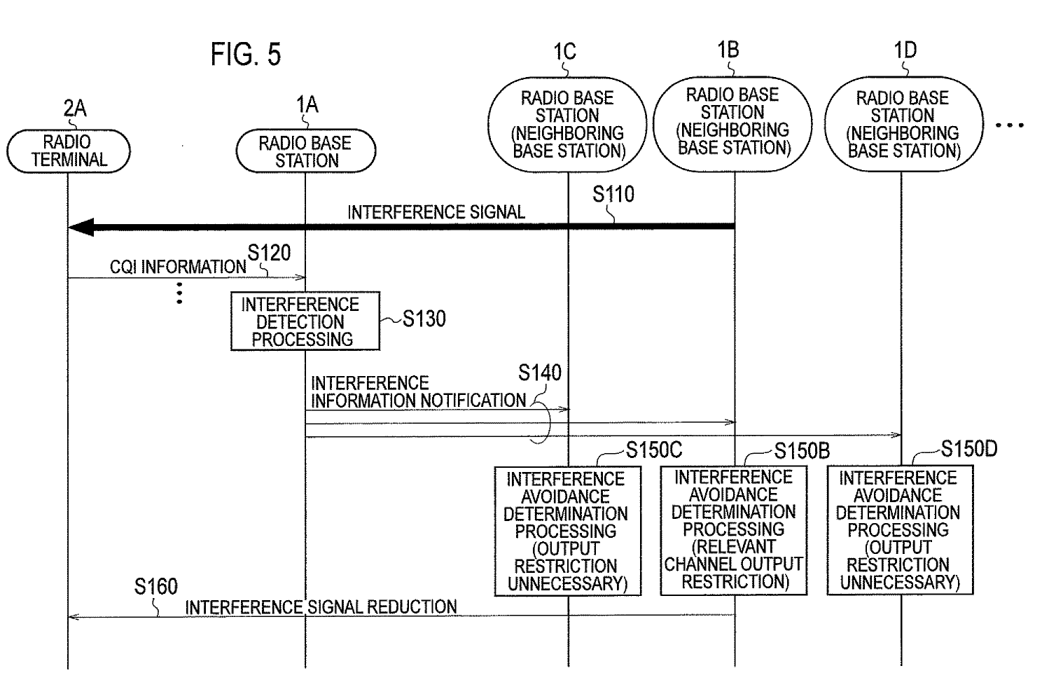

FIG. 5 is a sequence diagram showing a schematic operation sequence of the radio communication system 10 according to the first embodiment.

In Step S110, the radio communication unit 210 of the radio base station 18 is transmitting the interference signal to the radio base station 1A.

In Step S120, the radio terminal 2A notifies the radio base station 1A of the CQI information. The radio terminal 2A thereafter notifies the radio base station 1A of the CQI information periodically. The CQI information acquiring unit 121a of the radio base station 1A acquires the notified CQI information. The location information acquiring unit 121b acquires the location information of the radio terminal 2A using any one of the methods A to C.

In Step S130, the information manager 122 and the interfered subband detector 123 of the radio base station 1A perform the interference detection processing for detecting an interfered subband. The interference detection processing will be described in detail later.

In Step S140, the notification processor 124 of the radio base station 1A notifies the neighboring radio base stations 1B to 10 of the interference information through the backbone network 100 when the interfered subband is detected.

In Step 150B, Step 1500, and Step 150D, the transmission determining unit 222 and the transmission controller 223 of each of the neighboring radio base stations 1B to 10 determines whether or not to perform interference avoidance processing.

In Step S160, the transmission determining unit 222 of the radio base station 1B determines that the interference signal is transmitted by the radio base station 1B and the transmission controller 223 performs output restriction (transmission power lowering herein) on the relevant communication channel.

(3.2) Operation of Radio Base Station 1A

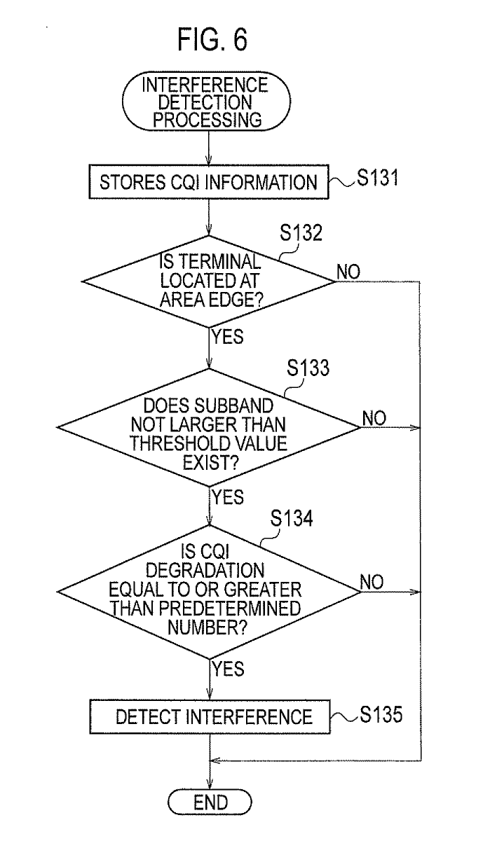

FIG. 6 is a flowchart showing an operation of the radio base station 1A according to the first embodiment, more specifically, a detail of Step S130 (interference detection processing) shown in FIG. 5.

In Step S131, the information manager 122 stores the CQI information in the CQI information storage unit 131 of the storage unit 130.

In Step S132, the location determining unit 122b determines whether the radio terminal 2A is located at the area edge 6A based on the location information. The location determination by the location determining unit 122b requires information on the area edge 6A. The information is assumed to be pre-stored in the storage unit 130. When the radio terminal 2A is determined to be located at the area edge 6A, the process proceeds to Step S133.

In Step S133, the degradation determining unit 122a determines whether or not a subband of which the CQI is degraded below the threshold value exists in the multiple subbands based on the CQI information. The counting unit 122c refers to the CQI information storage unit 131 and counts the number of times the CQI is degraded below the threshold value for the degraded subband. When it is determined that the subband of which the CQI is degraded below the threshold value exists, the process proceeds to Step S134.

In Step S134, when the number of times counted by the counting unit 122c for the degraded subband reaches a predetermined number (S134; YES), the interfered subband detector 123 detects the degraded subband as the interfered subband (Step S135).

(3.3) Operation of Radio Base Station 1B

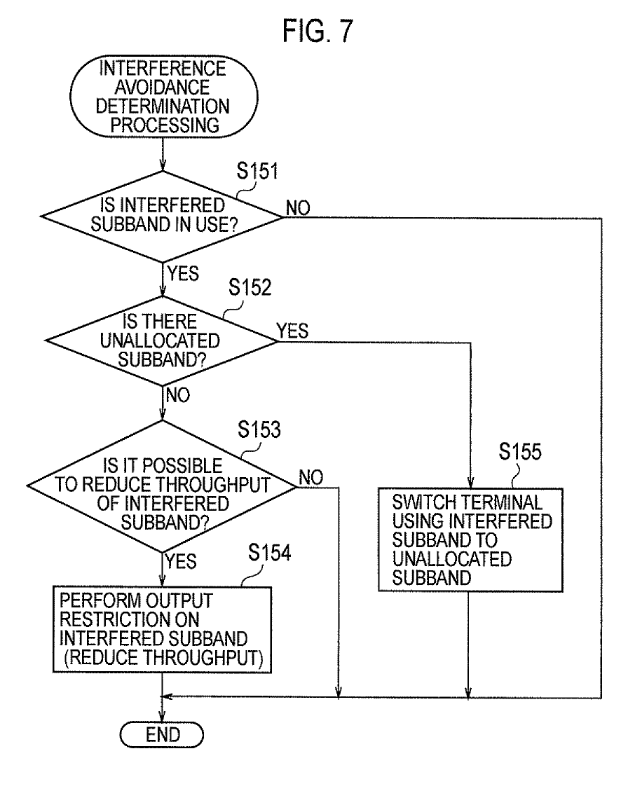

FIG. 7 is a flowchart showing an operation of the radio base station 1B, more specifically, a detail of Step S150B (interference avoidance determination processing) shown in FIG. 5.

In Step S151 the transmission determining unit 222 determines whether or not the communication channel of a frequency corresponding to the interfered subband is used based on the allocation information managed by the allocation manager 221. When it is determined that the communication channel of the frequency corresponding to the interfered subband is used, the process proceeds to Step S152.

In Step S152, the transmission controller 223 determines whether or not there is an unallocated subband (or communication channel) in the subbands except for the interfered subband based on the allocation information managed by the allocation manager 221. The processing proceeds to Step S155 if it is determined that there is an unallocated subband (communication channel), whereas the process proceeds to Step S153 if it is determined that there is no unallocated subband (communication channel).

In Step S155, the transmission controller 223 stops using the communication channel (interfered subband) that has been allocated to the radio terminal 2B, i.e., stops transmitting the interference signal and reallocates the communication channel corresponding to the unallocated subband to the radio terminal 2B.

In Step S153, the transmission controller 223 determines whether or not the throughput for the radio terminal 2B can be lowered. For example, it is determined that the throughput can be lowered when the amount of data destined to the radio terminal 2B is small.

In Step S154, the transmission controller 223 continues the use of the communication channel (interfered subband) that has been allocated to the radio terminal 2B but lowers the transmission power for the communication channel. In this case, a low-speed modulation scheme is used and thus the throughput is lowered.

Still, the influence of the interference to the radio terminal 2A can be reduced.

(4) Advantageous Effects

In the first embodiment, the notification processor 124 notifies the radio base station 1B of the interference information when the interfered subband is detected. When it is determined that the radio base station 1B is transmitting the interference signal, the transmission controller 223 of the radio base station 1B performs any one of the transmission power lowering and the transmission stop for the transmission of the interference signal. Thus, the CQI of the interfered subband is improved.

Accordingly, even when the subband (interfered subband) of which the CQI is degraded is allocated to the radio terminal 2A, the CQI of the subband can be improved and the stable and high-speed radio communications can be achieved.

In the situation where the amount of traffic transmitted and received by the radio base station is large and thus causes the communication resource shortage, the subband (interfered subband) of which the CQI is degraded is likely to be allocated to the radio terminal 2A. Thus, the present invention is especially effective in such a situation.

In the first embodiment, the interfered subband detector 123 detects a subband of which CQI is degraded as the interfered subband when the location determining unit 122b determines that the radio terminal 2A is located at the area edge 6A and the degradation determining unit 122a determines that the subband with degraded CQI exists. As shown in FIG. 1 and FIG. 2, the area edge 6A is an area where a radio terminal is likely to be affected by the interference. Thus, the interfered subband can be more accurately detected by taking into consideration whether a radio terminal is at the area edge 6A.

In the first embodiment, the interfered subband detector 123 detects a subband of which CQI is degraded as the interfered subband when the degradation determining unit 122a determines that a subband with degraded CQI exists and the number of times counted by the counting unit 122c for the subband with the degraded CQI reaches the predetermined number. Thus, the interfered subband can be even more accurately detected with a momentary degradation of CQI excluded.

In the first embodiment, the radio terminal 2A extracts predetermined number of lowest CQIs from the CQIs measured for respective multiple subbands and notifies the radio base station 1A of the CQI information indicating the predetermined number of extracted lowest CQIs. Thus, the radio base station 1A can determine the degraded subband while an information amount of the CQI information can be reduced compared with the case where the CQIs of all the subbands are transmitted.

In the first embodiment, the transmission controller 223 stops using the subband (interfered subband) that has been allocated to the radio terminal 2B when the transmission determining unit 222 determines that the radio base station 1B is transmitting the interference signal, and reallocates the communication channel corresponding to the unallocated subband to the radio terminal 2B. Thus, the communications with the radio terminal 2B can be continued while avoiding the interference more surely.

In the first embodiment, if it is determined that there is no unallocated subband, the transmission controller 223 continues the use of the subband (interfered subband) that has been allocated to the radio terminal 2B but performs the transmission power lowering. Thus, the communications with the radio terminal 2B can be continued while the influence of the interference is lowered even if there is no unallocated subband.

### Second Embodiment

As a second embodiment, an embodiment is described in which a radio base station serving as an interference source is identified from among the neighboring radio base stations 1B to 1G in addition to the configuration and the operation described in the first embodiment. In the following, descriptions are given of (1) a configuration of a radio base station, (2) an overall schematic operation, (3) an operation of the radio base station, and (4) advantageous effects. Note that descriptions overlapping with those in the first embodiment are omitted.

(1) Configuration of Radio Base Station

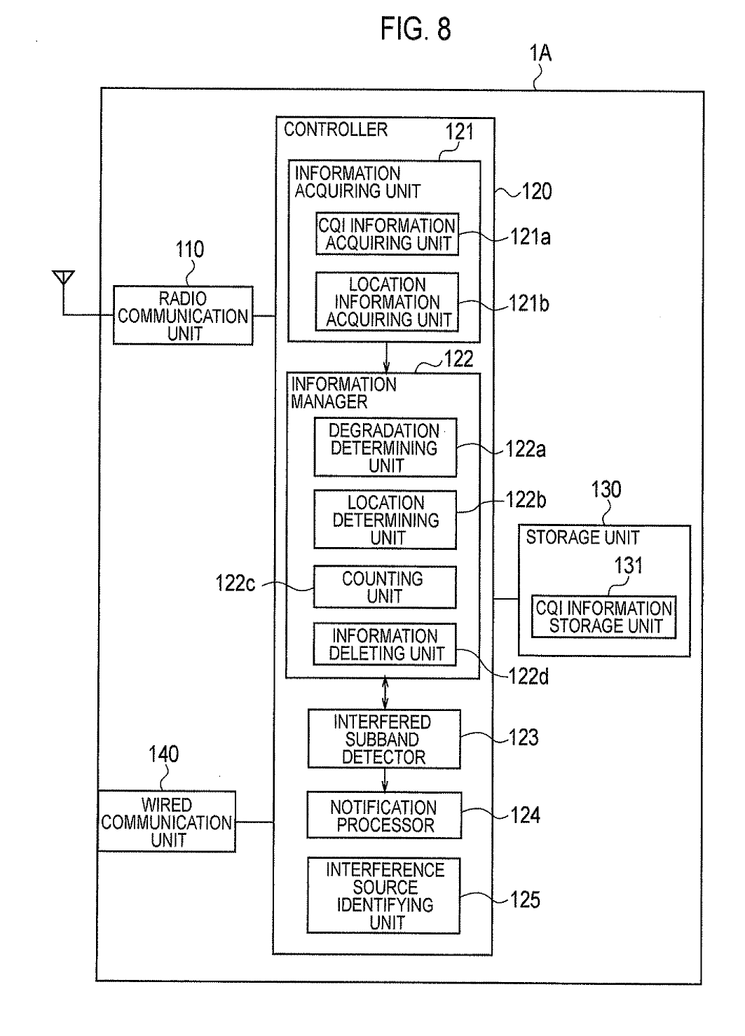

FIG. 8 is a functional block diagram showing a configuration of a radio base station 1A according to the second embodiment.

As shown in FIG. 8, the radio base station 1A further includes an interference source identifying unit 125 in addition to the configuration of the first embodiment. The interference source identifying unit 125 identifies a radio base station (hereinafter, referred to as interference source radio base station) transmitting an interference signal to the radio terminal 2A, thereby serving as the interference source from among the neighboring radio base stations 1B to 1G when the interfered subband detector 123 detects the interfered subband.

Upon storing the CQI information in the CQI information storage unit 131, the information manager 122 according to the second embodiment estimates the radio base station nearest to the radio terminal 2A from among the neighboring radio base stations 1B to 1G based on the location information of each radio terminal 2A and groups the CQIs for each of the neighboring radio base stations 1B to 1G. Due to the storing in the grouping manner, the interference source detector 125 can identify the interference source base station related to the interfered subband detected by the interfered subband detecting unit 123.

To estimate the radio base station nearest to the radio terminal 2A, location information (hereinafter, base station location information) for each of the neighboring radio base stations 1B to 1G is required. The base station location information is pre-stored in the storage unit 130. Thus, the location information acquiring unit 121b can acquire the base station location information from the storage unit 130 and use it for the estimation of the radio base station nearest to the radio terminal 2A.

Alternatively, information indicating the communication area of each of the neighboring radio base stations 15 to 1G may be used as the base station location information. In this case, the interference source identifying unit 125 identifies as the interference source base station, a neighboring radio base station that forms a communication area including the location of the radio terminal 2A from among the neighboring radio base stations 1B to 1G.

The notification processor 124 transmits an instruction message instructing any one of the transmission power lowering and the transmission stop for the interference signal to the interference source base station identified by the interference source identifying unit 125. This happens when the interfered subband detector 123 detects the interfered subband. More specifically, in the second embodiment, the notification processor 124 serves as an instructing unit that instructs any one of the transmission power lowering and the transmission stop for the interference signal.

(2) Overall Operation

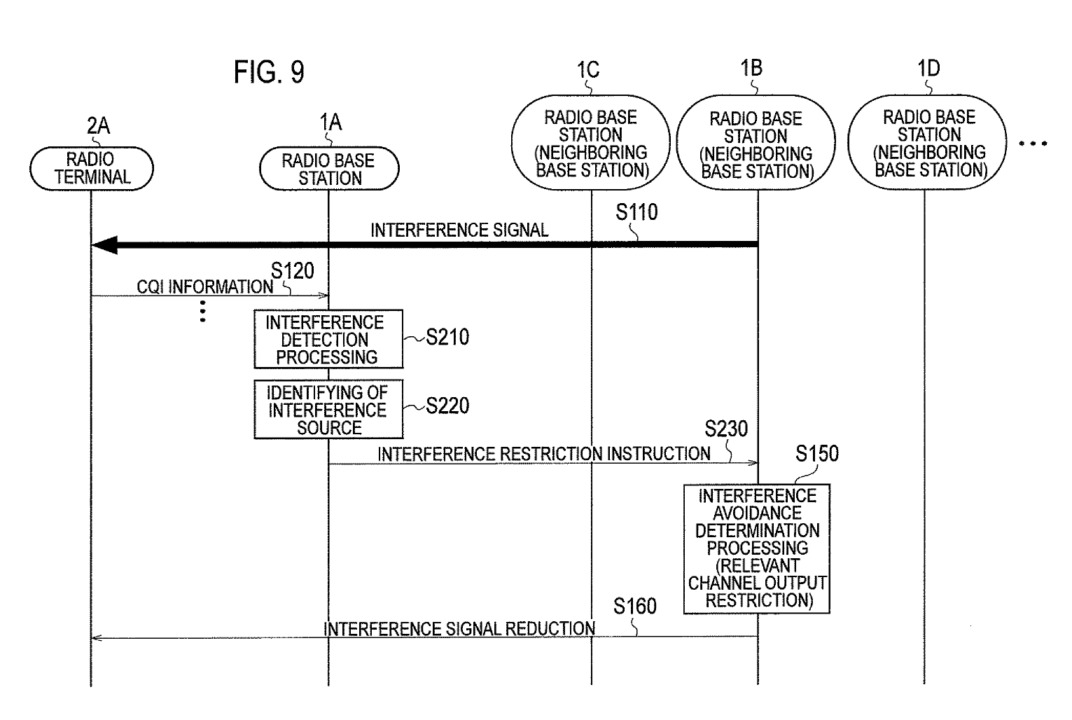

FIG. 9 is a sequence diagram showing a schematic operation sequence of a radio communication system 10 according to the second embodiment. In FIG. 9, operations in Steps other than those in Steps S210 to 5230 are the same and thus, the description is given of Steps S210 to 5230.

In Step S210, the information manager 122 and the interfered subband detector 123 of the radio base station 1A perform interference detection processing for detecting the interfered subband. The interference detection processing is described in detail later.

In Step S220, the interference source identifying unit 125 of the radio base station 1A identifies the interference source base station from among the neighboring radio base stations 1B to 1G. Here, the radio base station 1B is assumed to be identified as the interference source base station.

In Step S230, the notification processor 124 of the radio base station 1A transmits the interference restriction signal to only the radio base station 1B through the backbone network 100 when the interference subband is detected.

(3) Operation of Radio Base Station

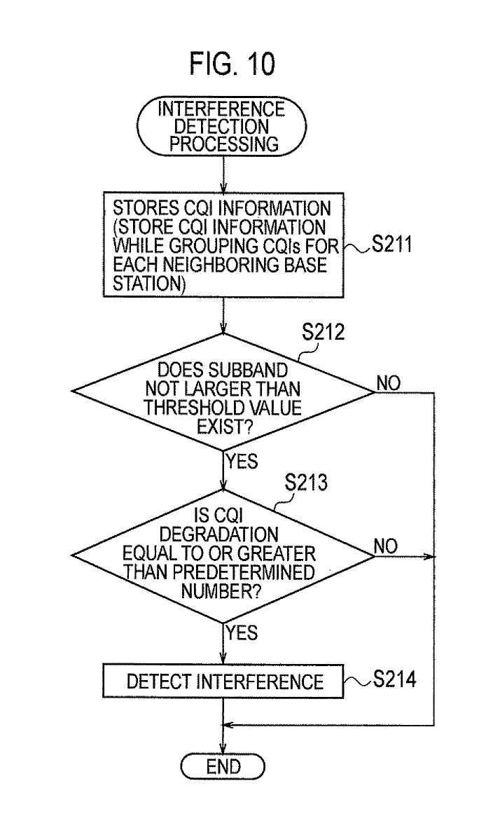

FIG. 10 is a flowchart showing an operation of the radio base station 1A according to the second embodiment, more specifically, a detail of Step S210 (interference detection processing) shown in FIG. 9. In FIG. 10, operations in Steps other than that in Step S211 are the same and thus, the description is given of Step S211. In Step S211, the information manager 122 stores the CQI information in the CQI information storage unit 131 of the storage unit 130. At this point, the information manager 122 estimates the radio base station nearest to the radio terminal 2A from among the neighboring radio base stations 1B to 1G based on the location information of each radio terminal 2A while grouping the CQIs for each of the neighboring radio base stations 1B to 1G.

(4) Advantageous Effects

In the second embodiment, the notification processor 124 transmits an instruction message instructing any one of the transmission power lowering and the transmission stop for the interference signal to the interference source base station identified by the interference source identifying unit 125. This happens when the interfered subband detector 123 detects the interfered subband. Thus, the amount of messages used for the notification can be reduced compared with the first embodiment in which the notification is given to all of the neighboring radio base stations 1B to 1G. Furthermore, in the first embodiment, there is a possibility that the interference avoidance operation is performed by the neighboring radio base stations 1B to 1G that is actually not the interference source. In the second embodiment such a possibility can be lowered.

As described above, the present invention has been described by using the embodiments of the present invention. However, it should not be understood that the description and drawings which constitute part of this disclosure limit the present invention. From this disclosure, various alternative embodiments, examples, and operation techniques will be easily found by those skilled in the art.

For example, the first embodiment and the second embodiment can be achieved independently or in combination.

The following method can be used in addition to the interference source base station identification method of the second embodiment. Specifically, the radio terminal 2A transmits cell IDs (base station identification information) of the neighboring radio base stations 1B to 1G that can be monitored, instead of the location information. Thus, the interference source identifying unit 125 can easily identify the interference source base station. Moreover, of the neighboring radio base stations 1B to 1G, a radio base station from which the radio terminal 2A is likely to receive interference can be previously identified by adding signal reception intensity from each of the neighboring radio base stations 1B to 1G along with the cell ID.

In the first embodiment and the second embodiment described above, the neighboring radio base stations 1B to 1G are exemplarily described as the interference source. However, not only such macro base stations but also a small base station (so-called femtocell) that forms a communication area in the communication area 5A of the radio base station 1A may be the target.

In the first embodiment and the second embodiment described above, the radio communication system 10 based on the LTE standard is described. However, the present invention is not limited to the LTE standard and can be also applied to a radio communication system based on WiMAX standard (IEEE 802.16) and the like.

In the first embodiment and the second embodiment described above, an example is described where a unit of a frequency for measuring the radio communication quality (subband) and a unit of allocating a frequency to a radio terminal (communication channel) are different. Instead, the unit of measurement and the unit of allocation may be the same.

As described above, it should be understood that the present invention includes various embodiments and the like which are not described herein. Accordingly, the technical scope of the present invention should be determined only by the matters to define the invention in the scope of claims regarded as appropriate based on the disclosure.

Note that the entire content of Japanese Patent Application No. 2008-287088 (filed on Nov. 7, 2008) and Japanese Patent Application No. 2008-287090 (filed on Nov. 7, 2008) is incorporated herein by reference.

### INDUSTRIAL APPLICABILITY

As described above, even when a communication frequency with a degraded radio communication quality is allocated to a radio terminal, the radio communication system, the radio base station, and the radio communication method according to the present invention can improve the radio communication quality in the communication frequency and achieves stable and high-speed radio communications, and thus are advantageously used for radio communications such as a mobile communication and the like.

1. A radio communication system comprising:
a first radio base station configured to perform radio communications with a radio terminal and to receive quality information indicating radio communication qualities from the radio terminal, the radio communication qualities being respectively measured for a plurality of communication frequencies available in the radio communications by the radio terminal;
a second radio base station located within a predetermined distance from the first radio base station and configured to be capable of communicating with the first radio base station, wherein
the first radio base station includes:
a detector configured to detect a communication frequency of which the radio communication quality is degraded below a threshold value as an interfered communication frequency from among the plurality of communication frequencies based on the quality information received from the radio terminal; and
an interference information notifying unit configured to notify the second radio base station of interference information indicating the interfered communication frequency when the interfered communication frequency is detected by the detector, and
the second radio base station includes a transmission controller configured to perform any one of transmission power lowering and transmission stop for an interference signal that is a radio signal for which the interfered communication frequency is used, when receiving the interference information from the first radio base station and when the second radio base station is transmitting the interference signal.

2. The radio communication system according to claim 1, wherein
the first radio base station further includes a location information acquiring unit configured to acquire location information indicating any one of a location of the radio terminal and a distance between the radio terminal and the first radio base station, and
the detector is configured to detect the degraded communication frequency as the interfered communication frequency when the degraded communication frequency exists and when the radio terminal is determined to be located in an edge portion of a communication area of the first radio base station based on the location information.

3. The radio communication system according to claim 1, wherein
the first radio base station further includes:
a quality information receiver configured to receive the quality information from the radio terminal for a plurality of times or to receive the quality information from a plurality of radio terminals including the radio terminal; and
a counting unit configured to count the number of times the radio communication quality degrades below the threshold value for each of the plurality of communication frequencies, and
the detector is configured to detect the degraded communication frequency as the interfered communication frequency when the degraded communication frequency exists and when the number of times counted by the counting unit for the degraded communication frequency reaches a predetermined number.

4. The radio communication system according to claim 1, wherein the radio terminal is configured:
to extract a predetermined number of lowest radio communication qualities from among the radio communication qualities respectively measured for the plurality of communication frequencies, and
to notify the first radio base station of the quality information indicating the predetermined number of the lowest radio communication qualities.

5. The radio communication system according to claim 1, wherein, when the interfered communication frequency is allocated to another radio terminal different from the radio terminal and when an unallocated communication frequency different from the interfered communication frequency exists, the transmission controller is configured to perform the transmission stop and to allocate the unallocated communication frequency to the other radio terminal.

6. The radio communication system according to claim 5, wherein the transmission controller is configured to perform the transmission power lowering when the unallocated communication frequency does not exist.

7. A radio base station configured to perform radio communications with a radio terminal and to receive quality information indicating radio communication qualities from the radio terminal, the radio communication qualities being respectively measured for a plurality of communication frequencies of a predetermined number by the radio terminal, the radio base station comprising:
a detector configured to detect a communication frequency of which the radio communication quality is degraded below a threshold value as an interfered communication frequency from among the plurality of communication frequencies based on the quality information received from the radio terminal; and
an interference information notifying unit configured to notify another radio base station located within a predetermined distance from the radio base station of interference information indicating the interfered communication frequency when the interfered communication frequency is detected by the detector.

8. A radio base station configured to perform radio communications with a radio terminal and to be capable of communicating with another radio base station that receives quality information indicating radio communication qualities from the radio terminal, the radio communication qualities being respectively measured for a plurality of communication frequencies available in the radio communications by the radio terminal, the radio base station comprising:
an interference information receiver configured to receive from the other radio base station, interference information indicating an interfered communication frequency of which the radio communication quality is degraded below a threshold value from among the plurality of communication frequencies; and
a transmission controller configured to perform any one of transmission power lowering and transmission stop for an interference signal that is a radio signal for which the interfered communication frequency is used when receiving the interference information by the interference information receiver in a case where the radio base station is transmitting the interference signal.

9. A radio communication method using:
a first radio base station configured to perform radio communications with a radio terminal and receive quality information indicating radio communication qualities from the radio terminal, the radio communication qualities being respectively measured for a plurality of communication frequencies available in the radio communications by the radio terminal; and
a second radio base station located within a predetermined distance from the first radio base station and configured to be capable of communicating with the first radio base station, the radio communication method comprising the steps of:
detecting a communication frequency of which the radio communication quality is degraded below a threshold value as an interfered communication frequency from among the plurality of communication frequencies based on the quality information received by the first radio base station from the radio terminal; and
notifying the second radio base station by the first radio base station of interference information indicating the interfered communication frequency when the interfered communication frequency is detected in the step of detecting the communication frequency, and
performing any one of transmission power lowering and transmission stop by the second radio base station for an interference signal that is a radio signal for which the interfered communication frequency is used when receiving the interference information by the second radio base station from the first radio base station and when the second radio base station is transmitting the interference signal.

10. A radio base station configured to perform radio communications with a radio terminal and receive quality information indicating radio communication qualities from the radio terminal, the radio communication qualities being respectively measured for a plurality of communication frequencies available in the radio communications by the radio terminal, the radio base station comprising:
a detector configured to detect a communication frequency of which the radio communication quality is degraded below a threshold value as an interfered communication frequency from among the plurality of communication frequencies based on the quality information received from the radio terminal;
an information acquiring unit configured to acquire terminal location information indicating a location of the radio terminal and base station location information on locations of other radio base stations within a predetermined rage from the radio base station;
an interference source identifying unit configured to identify an interference source base station transmitting to the radio terminal an interference signal that is a radio signal for which the interfered communication frequency is used from among the other radio base stations based on the terminal location information and the base station location information when the interfered communication frequency is detected by the detector; and
an instructing unit configured to instruct any one of transmission power lowering and transmission stop for the interference signal to the interference source base station identified by the interference source identifying unit.

11. The radio base station according to claim 10 further comprising:
a quality information receiver configured to receive the quality information from the radio terminal for a plurality of times or receive the quality information from a plurality of radio terminals including the radio terminal; and
a counting unit configured to count the number of times the radio communication quality degrades below the threshold value for each of the plurality of communication frequencies, wherein
the detector is configured to detect the degraded communication frequency as the interfered communication frequency when the degraded communication frequency exists and when the number of times counted by the counting unit for the degraded communication frequency reaches a predetermined number.

12. The radio base station according to claim 10 wherein, the detector is configured to detect the degraded communication frequency as the interfered communication frequency when the degraded communication frequency exists and when the radio terminal is determined to be located in an edge portion of a communication area of the radio base station based on the terminal location information.

13. The radio base station according to claim 10 wherein, the quality information received from the radio terminal indicates a predetermined number of lowest radio communication qualities from among the radio communication qualities respectively measured for the plurality of communication frequencies by the radio terminal.

14. The radio base station according to claim 10 wherein, the interference source identifying unit is configured:
to calculate the distance between the radio terminal and each of the other radio base stations, and
to identify a radio base station with the shortest measured distance as the interference source base station from among the other radio base stations.

15. The radio base station according to claim 10 wherein,
the base station location information includes information indicating a communication area formed by each of the other radio base stations, and
the interference source identifying unit is configured to identify a radio base station forming the communication area including the location of the radio terminal as the interference source base station from among the other radio base stations.

16. The radio base station according to claim 10 wherein,
the information acquiring unit is configured to acquire base station identifying information for identifying the interference source base station instead of the terminal location information and the base station location information, the base station identifying information being included in the interference signal received by the radio terminal, and
the interference source identifying unit is configured to identify the interference source base station based on the base station identifying information.

17. A radio communication method used in a radio base station configured to perform radio communications with a radio terminal and receive quality information indicating radio communication qualities from the radio terminal, the radio communication qualities being respectively measured for a plurality of communication frequencies available in the radio communications by the radio terminal, the radio communication method comprising the steps of:
detecting a communication frequency of which the radio communication quality is degraded below a threshold value as an interfered communication frequency from among the plurality of communication frequencies based on the quality information received from the radio terminal; and
acquiring terminal location information indicating a location of the radio terminal and base station location information on locations of other radio base stations within a predetermined rage from the radio base station;
identifying an interference source base station transmitting to the radio terminal an interference signal that is a radio signal for which the interfered communication frequency is used from among the other radio base stations based on the terminal location information and the base station location information when the interfered communication frequency is detected in the step of detecting the communication frequency; and
instructing any one of transmission power lowering and transmission stop for the interference signal to the interference source base station identified in the step of identifying the interference source base station.
